(19) United States
(12) Patent Application Publication
(10) Pub. No.: US 2023/0269454 A1
(43) Pub. Date: Aug. 24, 2023

(54) IMAGING DEVICE AND IMAGING METHOD

(71) Applicant: NIDEC COPAL CORPORATION, Tokyo (JP)

(72) Inventors: Yuusuke SUZUKI, Tokyo (JP); Yusuke AKAMATSU, Tokyo (JP)

(21) Appl. No.: 18/173,061

(22) Filed: Feb. 23, 2023

(30) Foreign Application Priority Data
Feb. 24, 2022 (JP) 2022-026717

(51) Int. Cl. H04N 23/55; H04N 23/56

(52) U.S. Cl. CPC H04N 23/55; H04N 23/56

(57) ABSTRACT

An imaging device includes an imaging element and an image processor that receive subject light through an opening in a housing and generate image data, an illuminometer that detects a brightness level in a surrounding environment, an illumination light source that emits illumination light, a switch including a first filter to prevent the illumination light from entering the imaging element and a second filter to allow the illumination light to enter the imaging element to place one of the first filter or the second filter on a front surface of the imaging element based on the brightness level in the surrounding environment detected by the illuminometer, and a setter that sets an amplification factor to be used by the image processor in generating the image data based on the brightness level in the surrounding environment detected by the illuminometer before the image processor starts generating the image data.

### RELATED APPLICATIONS

The present application claims priority to Japanese Application Number 2022-026717, filed Feb. 24, 2022, the disclosure of which is hereby incorporated by reference herein in its entirety.

### BACKGROUND

### Technical Field

The present invention relates to an imaging device and an imaging method.

### Description of the Background

Surveillance cameras are installed at various places such as nursing care facilities, hospitals, factories, and stores for crime and disaster prevention. Surveillance cameras are to capture an image during day and night when the illuminance level in the surrounding environment is low.

Patent Literature 1 describes a camera incorporating an image processing device that detects the illuminance level in the surrounding environment when an image is obtained, and corrects the graduation characteristics of the luminance of the obtained image based on the detected illuminance level.

### CITATION LIST

### Patent Literature

Patent Literature 1: Japanese Unexamined Patent Application Publication No. 2017-135554

### BRIEF SUMMARY

However, the camera described in Patent Literature 1 includes an illuminometer not in operation in a stop mode. When switching from the stop mode to an operation mode, the camera is to detect the illuminance level in the surrounding environment after starting the operation of the illuminometer. This causes a delay before image data is generated with appropriate luminance after the stop mode is switched to the operation mode.

An imaging device according to an aspect of the present invention includes an imager that receives subject light through an opening in a housing and generates image data, a detector that detects a brightness level in a surrounding environment, an illumination light source that emits illumination light, a switch including a first portion to prevent the illumination light from entering the imager and a second portion to allow the illumination light to enter the imager to place one of the first portion or the second portion on a front surface of the imager based on the brightness level in the surrounding environment detected by the detector, and a setter that sets an amplification factor to be used by the imager in generating the image data based on the brightness level in the surrounding environment detected by the detector before the imager starts generating the image data.

An imaging method according to another aspect of the present invention includes receiving subject light through an opening in a housing and causing an imager to generate image data, detecting a brightness level in a surrounding environment, causing an illumination light source to emit illumination light, placing one of a first portion being a portion to prevent the illumination light from entering the imager or a second portion being a portion to allow the illumination light to enter the imager on a front surface of the imager based on the detected brightness level in the surrounding environment, and setting an amplification factor to be used by the imager in generating the image data based on the detected brightness level in the surrounding environment before the imager starts generating the image data.

The technique according to the above aspects of the present invention shortens the time taken to generate image data with an appropriate amplification factor.

### BRIEF DESCRIPTION OF DRAWINGS

FIG. 1 is an external view of an imaging device according to an embodiment.

FIG. 2 is an internal plan view of the imaging device.

FIG. 3 is a block diagram of a control system in the imaging device.

FIG. 4 is a flowchart of a process performed by the imaging device.

FIG. 5 is a flowchart of a process performed by an imaging device according to a modification.

### DETAILED DESCRIPTION

One or more embodiments of the present invention will now be described in detail with reference to the drawings.

An imaging device according to the present embodiment may be used for any purpose and may be installed, for example, at a hospital, a nursing care facility, a factory, and a store as a surveillance camera or a monitoring camera. The imaging device is switchable between a normal imaging mode and a low-light imaging mode based on the brightness level in the external environment surrounding the imaging device. The imaging in the normal imaging mode is performed using light incident on the imaging optical system when the external environment is bright. The imaging in the low-light imaging mode is performed using illumination light emitted when the external environment is dark to allow imaging of a subject using the illumination light.

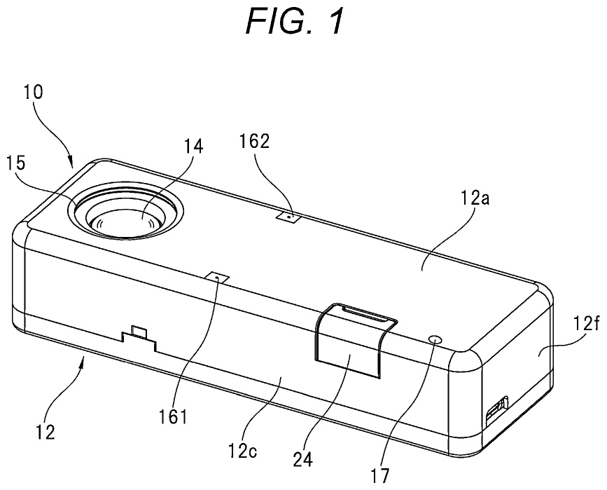

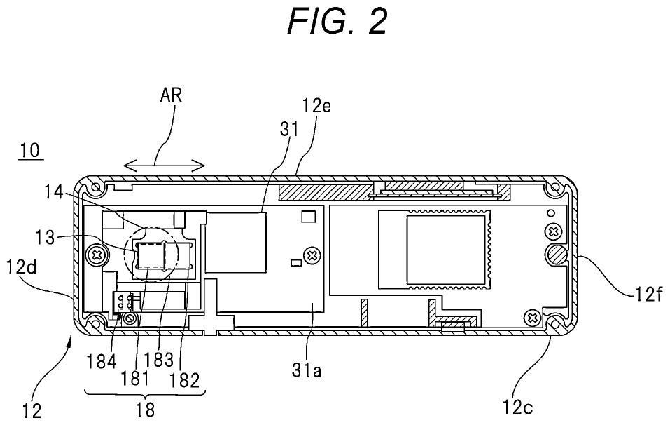

FIG. 1 is an external view of an imaging device 10. FIG. 2 is an internal plan view of the imaging device 10.

As shown in FIGS. 1 and 2, the imaging device 10 includes a substantially rectangular housing 12. The housing 12 has a front surface 12a and side surfaces 12c, 12d, 12e, and 12f that meet the sides of the front surface 12a. Hereafter, the front surface 12a of the housing 12 is referred to as being upward, the surface of the housing 12 opposite to the front surface 12a being downward, the side surface 12c being frontward, the side surface 12d being leftward, and the side surface 12f being rightward.

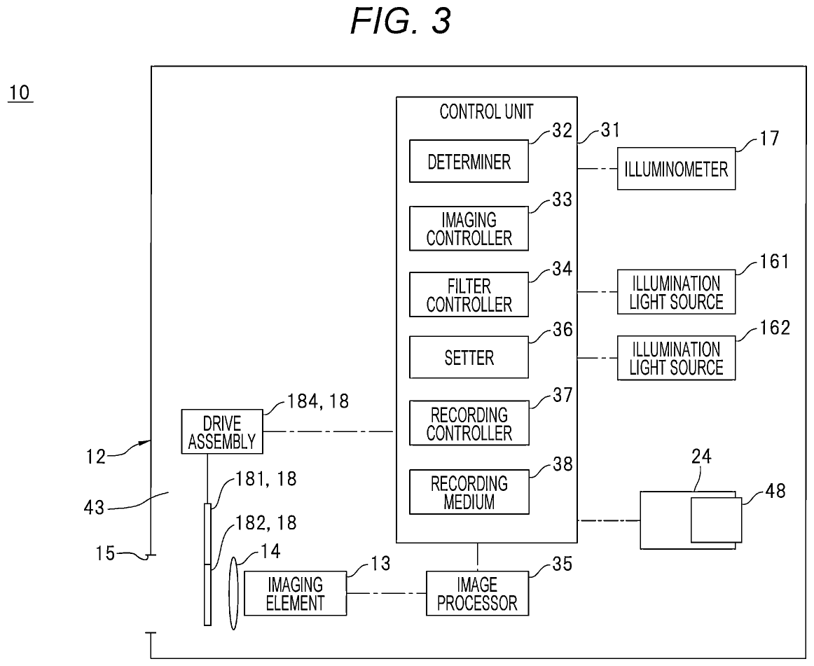

The housing 12 has, in or on the front surface 12a, a card slot 24 to receive a memory card 48 (refer to FIG. 3) and an opening 15, and illumination light sources 161 and 162 and an illuminometer 17.

The illumination light sources 161 and 162 are, for example, light-emitting diodes (LEDs) that emit light with wavelengths in the infrared region (infrared rays or infrared light). In the low-light imaging mode (described later), the imaging device 10 emits infrared light from the illumination light sources 161 and 162 as illumination light to illuminate a subject.

The illuminometer 17, which may be a photoresistor or a photodiode, is a detector that receives light from the surrounding environment (external environment) of the imaging device 10 and outputs a signal (luminance signal).

As shown in FIG. 2, the housing 12 in the imaging device 10 accommodates an imaging element 13 that is an image sensor such as a complementary metal-oxide semiconductor (CMOS) or a charge-coupled device (CCD), a lens 14 (imaging optical system) that focuses light from a subject (subject light) onto the imaging surface of the imaging element 13, a switch 18, and a control unit 31. The imaging element 13, the lens 14, and the switch 18 are arranged parallel to the front surface 12a.

The opening 15 in the front surface 12a of the housing 12 is on the optical axis of the lens 14. Subject light passing through the opening 15 enters the imaging element 13 through the lens 14 (imaging optical system). The imaging element 13 receives subject light through the opening 15 in the housing 12 and outputs an image signal resulting from photoelectric conversion. An image processor 35 (refer to FIG. 3), which is an image signal processor (ISP), described later processes the output image signal through various processes to generate image data. More specifically, the imaging element 13 and the image processor 35 function as an imager that receives subject light entering through the opening 15 in the front surface 12a of the housing 12 and generates image data.

The switch 18 switches between the state in which no illumination light from the illumination light sources 161 and 162 is allowed to enter the imaging element 13 and the state in which illumination light is allowed to enter the imaging element 13 based on the brightness level (luminance) in the external environment of the imaging device 10. More specifically, the switch 18 includes a first filter 181, a second filter 182, a holder 183, and a drive assembly 184. The first filter 181 is an infrared ray cut filter. The first filter 181 functions as a first portion that does not allow infrared light to enter the imaging element 13. The second filter 182 is, for example, a dummy lens, and functions as a second portion that allows infrared light to enter the imaging element 13.

The holder 183 holds the first filter 181 and the second filter 182 within a plane parallel to the front surface 12a. The holder 183 holds the first filter 181 on the left and the second filter 182 on the right in the direction indicated by arrow AR shown in FIG. 2. The holder 183 is movable in the direction indicated by arrow AR (in other words, the direction in which the first filter 181 and the second filter 182 are held). As the holder 183 moves along arrow AR, either the first filter 181 or the second filter 182 is placed on the optical axis of the lens 14 (in other words, the front surface of the imaging element 13).

The drive assembly 184 includes, for example, a drive, such as a stepping motor or a gear coupler, and a guide such as a lead screw. The drive assembly 184 is thus connected to the holder 183. When the drive assembly 184 is driven in response to a control signal from the control unit 31 (described later), the holder 183 connected to the drive assembly 184 moves along the plane parallel to the front surface 12a in the direction indicated by arrow AR.

A substrate 31a is a base for holding the imaging element 13 and the control unit 31. The substrate 31a is installed in a lower portion of the housing 12.

The control unit 31 includes a central processing unit (CPU), a memory, and other components. The control unit 31 is a processor that may read and execute a control program prerecorded in a recording medium 38 (refer to FIG. 3), such as a flash memory, to control various components of the imaging device 10. The control unit 31 controls the components in the normal imaging mode or the low-light imaging mode in an imaging process to operate the components. The normal imaging mode is used when the external environment of the imaging device 10 is bright. The low-light imaging mode is used when the external environment of the imaging device 10 is dark and lacks a sufficient amount of light. In the low-light imaging mode, the imaging device 10 applies infrared light as illumination light and captures an image of the subject illuminated with the infrared light.

The processing performed by the control unit 31 will be described in detail later.

### Control System for Imaging Device 10

FIG. 3 is a block diagram of the control system in the imaging device 10. As shown in FIG. 3, the control unit 31 in the imaging device 10 includes a determiner 32, an imaging controller 33, a filter controller 34, a setter 36, a recording controller 37, and the recording medium 38.

The determiner 32 performs a determination process to determine whether the external environment surrounding the imaging device 10 is bright or dark based on a luminance signal output from the illuminometer 17.

The imaging controller 33 controls driving of the imaging element 13 to cause the imaging element 13 to generate an image signal. The imaging controller 33 then performs the imaging process that causes the image processor 35 to generate image data based on the image signal. In imaging in the low-light imaging mode (described later), the imaging controller 33 supplies power to the illumination light sources 161 and 162 to cause infrared light to be output as illumination light.

Based on a determination result from the determiner 32, the filter controller 34 controls movement of the holder 183 by driving the drive assembly 184 to place the first filter 181 or the second filter 182 on the optical axis of the lens 14. In this case, the filter controller 34 places the first filter 181 that is an infrared ray cut filter on the optical axis of the lens 14 in the normal imaging mode, and places the second filter 182 that is a dummy lens on the optical axis of the lens 14 in the low-light imaging mode.

The setter 36 performs a setting process to set an amplification factor to be used by the image processor 35 in switching to the low-light imaging mode (in other words, when the external environment surrounding the imaging device 10 is dark) during a standby process performed before an imaging condition (described later) is satisfied.

The recording controller 37 performs a recording process to record image data generated by the image processor 35 into the memory card 48.

### Processing Performed by Control Unit 31

The imaging device 10 generates image data and records the data into the memory card 48 with an imaging method described below. The imaging method includes the standby process performed when the imaging condition is unsatisfied (in other words, in the closed state) and the imaging process performed when the imaging condition is satisfied. The imaging condition includes a wireless tag, such as an integrated circuit (IC), approaching a predetermined range. In this case, the control unit 31 determines whether a person carrying a wireless tag has entered a predetermined imaging area based on the intensity of a signal received with a radio communication module (not shown) connected to the control unit 31. When the intensity of the received signal exceeds a predetermined threshold Xa, the control unit 31 determines that the person has entered the imaging area, or in other words, the imaging condition is satisfied.

The imaging condition may include, for example, receiving a recording signal transmitted from a mobile terminal such as a smartphone, receiving an infrared ray transmitted from a remote control, and detecting a voice with predetermined information with a microphone (not shown).

When the imaging condition is unsatisfied, the imaging device 10 performs the standby process. When the imaging condition is satisfied, the imaging device 10 performs the imaging process after performing an imaging preparation process.

### Standby Process

In the standby process, the setter 36 in the control unit 31 performs the setting process to set an amplification factor to be used by the image processor 35 to amplify the image signal to generate the image data.

### Setting Process

The setter 36 calculates a luminance value based on a luminance signal output from the illuminometer 17 and sets an amplification factor for the image signal based on the calculated luminance value. Typically, when the imaging device 10 captures an image, a smaller amount of light enters the imaging element 13 with its external environment being dark (in the low-light imaging mode) than with its external environment being bright (in the normal imaging mode). The setter 36 thus sets a higher amplification factor for the image processor based on the calculated luminance value as the external environment is darker (in other words, the luminance value is lower).

More specifically, amplification factors are prepared based on luminance values (brightness levels in the external environment) and are recorded in the recording medium 38 in, for example, a tabular format. The table includes the luminance values in the external environment divided into predetermined ranges, for which different amplification factors are recorded. For example, an amplification factor a is associated with a luminance value in the external environment being in a first range A. An amplification factor b lower than the amplification factor a is associated with a luminance value in the external environment being in a second range B indicating being brighter than in the first range A. An amplification factor c lower than the amplification factor b is associated with a luminance value in the external environment being in a third range C indicating being brighter than the second range B. An amplification factor d lower than the amplification factor c is associated with a luminance value in the external environment being in a fourth range D indicating being brighter than the third range C. An amplification factor e lower than the amplification factor d is associated with a luminance value in the external environment being in a fifth range E indicating being brighter than the fourth range D.

The setter 36 determines a range including the calculated luminance value among the first range A to the fifth range E by referring to the above table. The setter 36 then sets the amplification factor associated with the range as an amplification factor to be set for the image processor 35. In other words, the setter 36 sets the value based on the calculated luminance value among values predetermined for brightness levels as the amplification factor.

The above table may include each value associated with the luminance value in the external environment as a correction value for the amplification factor instead of the amplification factor. In this case, for example, a luminance value calculated using the image signal output from the imaging element 13 under natural light is 1 (in other words, a reference value), and the correction value for the amplification factor is set as the amount of correction to the reference value. The amount of correction may be the difference from the above reference value or the ratio to the reference value.

### Imaging Preparation Process

As the imaging preparation process, the control unit 31 performs the determination process and a low-light imaging mode setting process based on the result of the determination process. In the determination process, the determiner 32 in the control unit 31 calculates a luminance value based on a luminance signal output from the illuminometer 17, and determines that the external environment is bright in response to the value exceeding a predetermined threshold and determines that the external environment is dark in response to the value being less than or equal to the threshold. In the low-light imaging mode setting process, the imaging controller 33 or the filter controller 34 in the control unit 31 controls the components to allow imaging in the low-light imaging mode after the imaging condition is satisfied. The determination process and the low-light imaging mode setting process will be described below.

### Determination Process

The determiner 32 calculates a luminance value based on a luminance signal output from the illuminometer 17, and determines that the external environment is bright in response to the value exceeding the predetermined threshold and determines that the external environment is dark in response to the value being less than or equal to the threshold. The predetermined threshold is set based on the results of testing or simulations, and is prerecorded in the recording medium 38.

### Low-Light Imaging Mode Setting Process

The imaging controller 33 controls the operation of each component in the imaging device 10 based on the determination result of the determination process.

When the luminance value is less than or equal to the threshold and the surrounding external environment is determined to be dark, the imaging controller 33 performs a process to allow imaging in the low-light imaging mode (described later). The filter controller 34 first controls the drive assembly 184 to move the first filter 181 off the optical axis of the lens 14 and place the second filter 182 on the optical axis of the lens 14. This allows infrared light to enter the imaging element 13. The imaging controller 33 then causes the illumination light sources 161 and 162 to emit infrared light as illumination light as described above.

When the luminance value exceeds the threshold and the surrounding external environment is determined to be bright, the control unit 31 does not perform the above imaging preparation process. More specifically, the filter controller 34 does not move the first filter 181 and maintains the first filter 181 on the optical axis of the lens 14. The imaging controller 33 does not allow the illumination light sources 161 and 162 to emit illumination light.

During the standby process and the imaging preparation process described above (in other words, until the imaging condition to start generating imaging data is satisfied), the imaging element 13 may not receive power and may stop driving, or the imaging element 13 may receive power but may continue to drive without outputting an image signal. The imaging device 10 may cause the imaging element 13 to stop or continue driving in a switchable manner in response to, for example, a setting operation performed by a user during the imaging preparation process and the standby process. This reduces the power consumption of the imaging device 10 until the imaging condition is satisfied.

In response to the above imaging preparation process being performed, the control unit 31 performs the imaging process.

### Imaging Process

The imaging controller 33 in the control unit 31 causes the imaging element 13 to receive subject light entering through the opening 15 and output an image signal to the image processor 35. When the imaging element 13 stops driving during the imaging preparation process and the standby process, the imaging controller 33 causes the imaging element 13 to start driving and then to generate the above image signal. With the second filter 182 on the optical axis of the lens 14 in the low-light imaging mode, the imaging element 13 receives illumination light emitted from the illumination light sources 161 and 162 and reflected from the subject, and outputs an image signal.

The image processor 35 subjects the image signal output from the imaging element 13 to known image processes, such as an analog-to-digital (AD) conversion process, a signal amplification process, and a white balance process, and generates image data. In this state, the image processor 35 amplifies the image signal with the amplification factor set in the setting process during the above standby process. The recording controller 37 records the generated image data into the memory card 48.

Hereafter, the imaging controller 33 sets an amplification factor both in the normal imaging mode and in the low-light imaging mode based on image data to be generated. The image processor 35 generates image data using the set amplification factor. In other words, the amplification factor for the image signal is controlled with auto gain control (AGC). In this case, the imaging controller 33 performs one of first control or second control, or switches between the first control and the second control as appropriate to set the amplification factor. For the first control, the imaging controller 33 sets the amplification factor using correction data (correction table) generated by calculating amplification factors based on image data generated at a test site. The correction data includes multiple amplification factors calculated using image data generated with different brightness levels in the external environment at a test site and associated with the luminance of the image data. The correction data is recorded in the recording medium 38. The imaging controller 33 reads, from the correction data, an amplification factor associated with the luminance of the image data generated by the imaging process and sets the factor as the amplification factor to be used. For the second control, the imaging controller 33 stores amplification factors calculated based on image data generated at an installation site and sets an amplification factor to be used. When performing the first control or the second control, the imaging controller 33 may set the amplification factor to be used using results obtained from, for example, artificial intelligence (AI) learning amplification factors calculated based on image data and stored.

When the imaging condition is no longer satisfied, the imaging controller 33 in the control unit 31 causes the imaging element 13 to stop outputting the image signal, and the image processor 35 to stop generating the image data. When the imaging element 13 is set to stop driving during the imaging preparation process and the standby process, the imaging controller 33 causes the imaging element 13 to stop driving. When imaging in the low-light imaging mode is performed, the filter controller 34 moves the first filter 181 to the optical axis of the lens 14, and the imaging controller 33 causes the illumination light sources 161 and 162 to stop emitting illumination light. However, the control unit 31 causes the illuminometer 17 to continue its operation without stopping the operation. Thus, the illuminometer 17 operates until the imaging condition is satisfied again. The setter 36 in the control unit 31 performs the setting process in the above standby process. When the imaging device 10 is in the closed state, the control unit 31 may supply power to the illuminometer 17 at predetermined intervals with, for example, pulse control (pulse-width modulation control, or PWM control).

The above standby process is performed to allow an amplification factor appropriate for imaging in the low-light imaging mode to be set in a shorter time than when the amplification factor is controlled and set with AGC in imaging in the low-light imaging mode after the imaging condition is satisfied. This reduces the delay before the imaging is started in the low-light imaging mode after the imaging condition is satisfied.

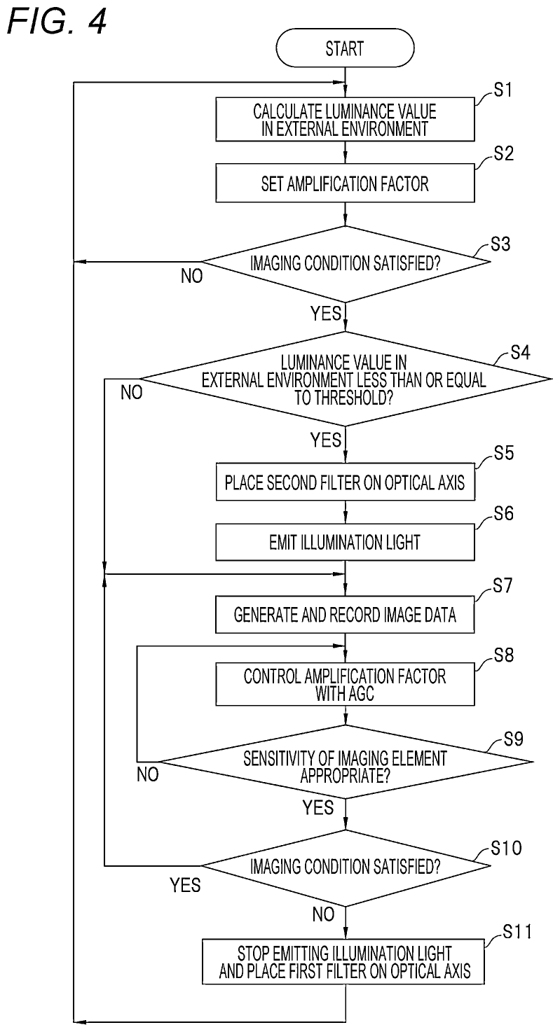

The process performed by the control unit 31 will be described with reference to the flowchart in FIG. 4. The control unit 31 reads and executes a program recorded in the recording medium 38 to perform the processing in the flowchart.

In step S1, the setter 36 in the control unit 31 calculates a luminance value in the external environment based on a luminance signal output from the illuminometer 17. The processing then advances to step S2. In step S2, the setter 36 reads the amplification factor recorded in the above table based on the calculated luminance value and sets the value as the amplification factor to be used by the image processor 35 in generating image data. The processing then advances to step S3. Steps S1 and S2 above correspond to the setting process.

In step S3, the control unit 31 determines whether the imaging condition is satisfied. When the intensity of the signal received with the radio communication module exceeds the threshold Xa as described above, the control unit 31 yields an affirmative determination result. The processing then advances to step S4. When the intensity of the received signal is less than or equal to the threshold Xa, the control unit 31 yields a negative determination result. The processing then returns to step S1.

In step S4, the determiner 32 in the control unit 31 determines whether the luminance value obtained in step S1 exceeds the predetermined threshold (determination process). When the calculated luminance value is less than or equal to the threshold (in other words, the external environment is dark), the determiner 32 yields an affirmative determination result. The processing then advances to step S5. When the luminance value exceeds the threshold (in other words, the external environment is bright), the determiner 32 yields a negative determination result. The processing then advances to step S7 (described later).

In step S5, the filter controller 34 in the control unit 31 controls the drive assembly 184 to move the first filter 181 off the optical axis of the lens 14 and place the second filter 182 on the optical axis of the lens 14. The processing then advances to step S6. In step S6, the imaging controller 33 in the control unit 31 causes the illumination light sources 161 and 162 to emit infrared light as illumination light as described above. The processing then advances to step S7. Steps S4 to S6 above correspond to the imaging preparation process.

In step S7, the imaging controller 33 causes the imaging element 13 and the image processor 35 to generate image data, and the recording controller 37 records the generated image data into the memory card 48. When the imaging element 13 stops driving, the imaging controller 33 causes the imaging element 13 to start driving and then to generate the above image signal. The processing then advances to step S8.

In step S8, the imaging controller 33 controls, with AGC, and calculates a new amplification factor based on the image data generated by the image processor 35. The imaging controller 33 then sets the calculated new amplification factor to be used by the image processor 35 in generating image data. The processing then advances to step S9.

In step S9, the determination is performed as to whether the sensitivity of the imaging element 13 is appropriate. When the sensitivity of the imaging element 13 is appropriate, the control unit 31 yields an affirmative determination result. The processing then advances to step S10. When the sensitivity of the imaging element 13 is inappropriate, the control unit 31 yields a negative determination result. The processing then returns to step S8. Steps S7 to S9 above correspond to the imaging process.

In step S10, the determination is performed as to whether the imaging condition is satisfied. When the intensity of the signal received with the radio communication module remains exceeding the threshold Xa, the control unit 31 yields an affirmative determination result. The processing then returns to step S7. When the intensity of the received signal is less than or equal to the threshold Xa, the control unit 31 yields a negative determination result. The processing then advances to step S11. In step S11, the imaging controller 33 in the control unit 31 causes the imaging element 13 to stop outputting the image signal, and the image processor 35 to stop generating the image data. When the imaging element 13 is set to stop driving during the imaging preparation process and the standby process, the imaging controller 33 causes the imaging element 13 to stop driving. When imaging in the low-light imaging mode is performed, the imaging controller 33 stops emitting illumination light from the illumination light sources 161 and 162, and the filter controller 34 controls the drive assembly 184 to move the holder 183 and place the first filter 181 on the optical axis of the lens 14. The processing then returns to step S1. In other words, the standby process in steps S1 and S2 (operation of the illuminometer 17) is continued.

When the luminance value detected by the illuminometer 17 is less than or equal to the threshold, at least either placing the first filter 181 on the optical axis of the lens 14 with the filter controller 34 or allowing emitting illumination light from the illumination light sources 161 and 162 with the imaging controller 33 may be performed before the imaging condition is satisfied. Thus, the processing in steps S3 to S6 may be performed before the processing in step S3 is performed.

The structure according to the above embodiment produces the advantageous effects described below.

(1) The setter 36 sets the amplification factor to be used by the image processor 35 in generating image data based on the brightness level (luminance) in the surrounding environment detected by the illuminometer 17 before the image processor 35 starts generating image data. This allows an amplification factor appropriate for imaging to be set when the imaging device 10 starts imaging. This structure reduces the delay before image data is generated with an amplification factor appropriate for imaging, as compared with when an amplification factor is controlled and set with AGC to start imaging.

(2) The setter 36 sets a value predetermined for each brightness level in the surrounding environment as the amplification factor. The amplification factor to be used is set to the amplification factor recorded in, for example, a tabular format, and can be set in a shorter time than when the amplification factor is calculated every time based on output from the illuminometer 17.

(3) When the brightness level (luminance) in the surrounding environment detected by the illuminometer 17 before the image processor 35 starts generating image data is less than or equal to the threshold, the switch 18 places the second filter 182 on the front surface of the imaging element 13. This structure reduces the delay before image data is generated with an appropriate amplification factor in the low-light imaging mode, as compared with when the second filter 182 for transmitting infrared light as illumination light is placed on the front surface of the imaging element 13 to start imaging.

(4) When the brightness level (luminance) in the surrounding environment detected by the illuminometer 17 before the image processor 35 starts generating the image data is less than or equal to the threshold, the illumination light sources 161 and 162 emit illumination light. This structure reduces the delay before image data is generated with an appropriate amplification factor in the low-light imaging mode, as compared with when illumination light is emitted to start imaging.

(5) When the condition (imaging condition) to start generating image data with the image processor 35 is unsatisfied, the illuminometer 17 detects the brightness level (luminance) in the surrounding environment, and the setter 36 sets the amplification factor. This causes the illuminometer 17 to operate during the standby process and detect the luminance in the surrounding environment of the imaging device 10 to set the amplification factor, thus reducing the delay before the imaging is started after the imaging condition is satisfied.

(6) When the brightness level (luminance) in the surrounding environment detected by the illuminometer 17 is less than or equal to the threshold after the condition (imaging condition) to start generating image data with the image processor 35 is satisfied, the switch 18 places the second filter 182 on the front surface of the imaging element 13. This allows illumination light to enter the imaging element 13 in starting imaging in the low-light imaging mode.

(7) When the brightness level (luminance) in the surrounding environment detected by the illuminometer 17 is less than or equal to the threshold after the condition (imaging condition) to start generating image data with the image processor 35 is satisfied, the illumination light sources 161 and 162 emit illumination light. This illuminates a subject with illumination light (infrared light) in starting imaging in the low-light imaging mode when the external environment is dark to allow imaging.

(8) After the image processor 35 starts generating image data, the imaging controller 33 sets the amplification factor with AGC based on the image data generated by the image processor 35. The amplification factor set during the standby process can be adjusted based on an amplification factor calculated based on subject light actually entering the imaging element 13, thus improving the image quality of image data to be generated.

The above embodiment may be modified in the forms described below.

### Modifications

In the above embodiment, the control unit 31 performs the setting process during the standby process performed before the imaging condition is satisfied, and the image processor sets the amplification factor. In the present modification, the control unit 31 performs the setting process after the imaging condition is satisfied. The imaging device 10 according to the modification has the same structure as the imaging device 10 according to the embodiment shown in FIG. 3.

When the imaging condition described in the embodiment is satisfied, the control unit 31 performs the imaging preparation process and the imaging process after performing the above setting process.

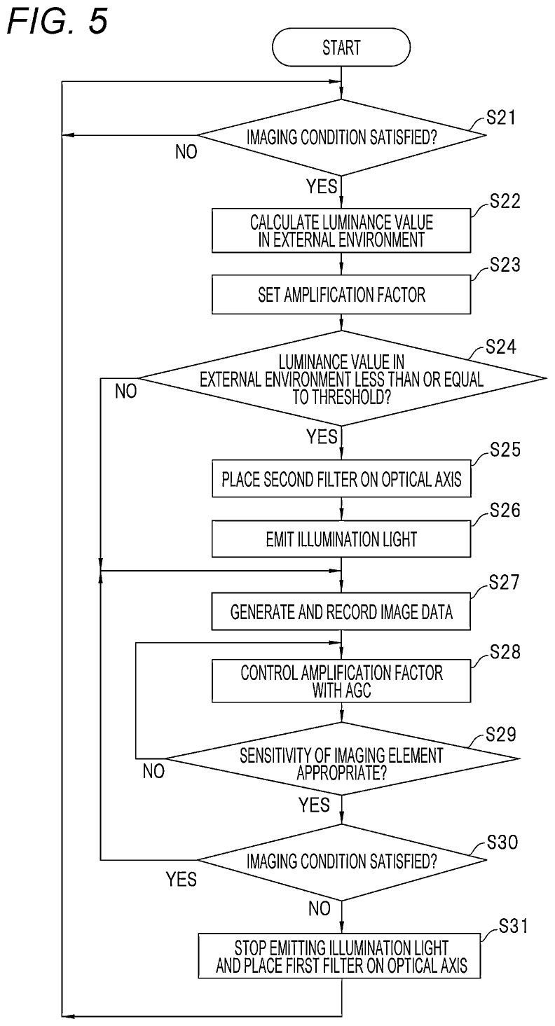

The process performed by the control unit 31 included in the imaging device 10 according to the modification will be described with reference to the flowchart shown in FIG. 5. The control unit 31 reads and executes a program recorded in the recording medium 38 to perform the processing in the flowchart.

In step S21, the control unit 31 determines whether the imaging condition is satisfied as in step S3 in the flowchart shown in FIG. 4. When the imaging condition is satisfied, the control unit 31 yields an affirmative determination result. The processing then advances to step S22. When the imaging condition is unsatisfied, the control unit 31 yields a negative determination result and repeats the processing.

Steps S22 and S23 are similar to steps S1 (calculating the luminance value in the external environment) and S2 (setting the amplification factor) in FIG. 4. The processing in steps S24 to S31 is the same as the processing in steps S4 (determination process) to S11 (stopping output of the image signal and generation of the image data) in FIG. 4. When imaging in the low-light imaging mode is performed, the imaging controller 33 stops emitting illumination light from the illumination light sources 161 and 162, and the filter controller 34 controls the drive assembly 184 to move the holder 183 and place the first filter 181 on the optical axis of the lens 14. The processing then returns to step S21.

The modification described above produces the advantageous effect (9) described below, in addition to the advantageous effects (1) to (4) and (6) to (8) described in the embodiment.

(9) When the condition (imaging condition) to start generating image data with the image processor 35 is satisfied, the illuminometer 17 detects the brightness level (luminance) in the surrounding environment, and the setter 36 sets the amplification factor. The amplification factor to be used is set to the amplification factor recorded in, for example, a tabular format, and can be set in a shorter time than when the amplification factor is calculated every time based on output from the illuminometer 17. This shortens the time taken to generate image data after the imaging condition is satisfied.

Although various embodiments and modifications are described above, the present invention is not limited to the embodiments and the modifications. Other forms implementable within the scope of technical idea of the present invention fall within the scope of the present invention.

What is claimed is:

1. An imaging device, comprising:
an imager configured to receive subject light through an opening in a housing and generate image data;
a detector configured to detect a brightness level in a surrounding environment;
an illumination light source configured to emit illumination light;
a switch including a first portion to prevent the illumination light from entering the imager and a second portion to allow the illumination light to enter the imager, the switch being configured to place one of the first portion or the second portion on a front surface of the imager based on the brightness level in the surrounding environment detected by the detector; and
a setter configured to set an amplification factor to be used by the imager in generating the image data based on the brightness level in the surrounding environment detected by the detector before the imager starts generating the image data.

2. The imaging device according to claim 1, wherein
the setter sets a value based on the brightness level in the surrounding environment detected by the detector among values predetermined for brightness levels as the amplification factor.

3. The imaging device according to claim 1, wherein
when the brightness level in the surrounding environment detected by the detector before the imager starts generating the image data is less than or equal to a threshold, the switch places the second portion on the front surface of the imager before the imager starts generating the image data.

4. The imaging device according to claim 3, wherein
when the brightness level in the surrounding environment detected by the detector before the imager starts generating the image data is less than or equal to a threshold, the illumination light source emits the illumination light before the imager starts generating the image data.

5. The imaging device according to claim 1, wherein
when a condition to start generating the image data with the imager is unsatisfied, the detector detects the brightness level in the surrounding environment and the setter sets the amplification factor.

6. The imaging device according to claim 1, wherein
when a condition to start generating the image data with the imager is satisfied, the detector detects the brightness level in the surrounding environment and the setter sets the amplification factor.

7. The imaging device according to claim 5, wherein
when the brightness level in the surrounding environment detected by the detector is less than or equal to a threshold after the condition to start generating the image data with the imager is satisfied, the switch places the second portion on the front surface of the imager.

8. The imaging device according to claim 5, wherein
when the brightness level in the surrounding environment detected by the detector is less than or equal to a threshold after the condition to start generating the image data with the imager is satisfied, the illumination light source emits the illumination light.

9. The imaging device according to claim 1, further comprising:
an imaging controller configured to set the amplification factor based on the image data generated by the imager after the imager starts generating the image data.

10. The imaging device according to claim 9, wherein
the imaging controller performs one of first control or second control to set the amplification factor, or switches between the first control and the second control to set the amplification factor, the first control is performed based on an amplification factor determined based on image data generated at a test site, and the second control is performed based on an amplification factor determined based on image data generated at an installation site.

11. The imaging device according to claim 10, wherein
when performing the first control or the second control, the imaging controller sets the amplification factor using a result obtained from learning the amplification factor determined based on the image data.

12. The imaging device according to claim 1, wherein
the imager continues to drive when a condition to start generating the image data is unsatisfied.

13. The imaging device according to claim 1, wherein
the imager stops driving until a condition to start generating the image data is satisfied.

14. An imaging method, comprising:
receiving subject light through an opening in a housing and causing an imager to generate image data;
causing a detector to detect a brightness level in a surrounding environment;
causing an illumination light source to emit illumination light;
placing one of a first portion or a second portion on a front surface of the imager based on the detected brightness level in the surrounding environment, the first portion being a portion to prevent the illumination light from entering the imager, the second portion being a portion to allow the illumination light to enter the imager; and
setting an amplification factor to be used by the imager in generating the image data based on the detected brightness level in the surrounding environment before the imager starts generating the image data.
